(19) United States
(12) Patent Application Publication
(10) Pub. No.: US 2009/0212516 A1
(43) Pub. Date: Aug. 27, 2009

(54) HAND TRUCK WITH ACTIVE IDENTIFIER(S)

(75) Inventor: Andrew P. Richard, Gladwin, MI (US)

Correspondence Address: REISING ETHINGTON P.C., P O BOX 4390, TROY, MI, 48099-4390, US

(73) Assignee: Magline, Inc., Pinconning, MI (US)

(21) Appl. No.: 12/390,914

(22) Filed: Feb. 23, 2009

Related U.S. Application Data
(60) Provisional application No. 61/031,207, filed on Feb. 25, 2008.

(51) Int. Cl. B62B 1/16

(52) U.S. Cl. 280/47.26

(57) ABSTRACT

A hand truck for carrying and transporting loads includes a frame, one or more wheels, and one or more active identifiers. The wheels are connected to the frame for moving the hand truck place to place. In one embodiment, the active identifier(s) includes a housing with a base connected to the frame and with a cover removably connected to the base. The active identifier(s) includes one or more light sources supported by the housing and enclosed by the cover. The active identifier(s) includes a power source supported by the housing in order to provide power to the light source(s).

### REFERENCE TO CO-PENDING APPLICATION

This application claims the benefit of, and incorporates by reference in its entirety, U.S. Provisional Application Ser. No. 61/031,207, filed Feb. 25, 2008.

### FIELD OF THE INVENTION

The present invention relates generally to hand trucks, and more particularly to ways of determining the location and position of hand trucks.

### BACKGROUND OF THE INVENTION

Various hand trucks have been used to transport goods from various modes of transportation (e.g., vans, trucks, boats, trains, etc.) and in and among buildings and the like. Such trucks have a load carrying surface and one or more wheels, and may be manually operated or driven at least in part by a motor or other device. The trucks are often used in a wide variety of environments and lighting conditions, including near total darkness.

### SUMMARY OF THE INVENTION

One embodiment of a hand truck may include a frame, one or more wheels, one or more active identifiers, and a control. The wheel(s) may be connected to the frame in order to move the hand truck from place to place. The active identifier(s) may be connected to the frame and may include one or more light sources that can be illuminated without ambient light. And the control may be electrically coupled to the active identifier(s) and may include a power source in order to provide power to the active identifier(s).

One embodiment of a hand truck may include a frame, one or more wheels, and one or more active identifiers. The wheel(s) may be connected to the frame to move the hand truck from place to place. The active identifier(s) may include a housing which itself may include a base connected to the frame and a cover removably connected to the base. The active identifier(s) may include one or more light sources supported by the housing and enclosed by the cover. The active identifier(s) may also include a power source supported by the housing in order to provide power to the light source(s).

### BRIEF DESCRIPTION OF THE DRAWINGS

The following detailed description of preferred embodiments and best mode will be set forth with reference to the accompanying drawings, in which:

FIG. 1 is a perspective view of an exemplary embodiment of a hand truck having an exemplary embodiment of an active identifier to facilitate locating the hand truck;

FIG. 2 is a front view of the hand truck of FIG. 1;

FIG. 3 is an enlarged, fragmentary front view of a portion of the hand truck as shown in FIG. 2;

FIG. 4 is a front view of an exemplary embodiment of a hand truck;

FIG. 5 is an enlarged view of an exemplary embodiment of an active identifier; and

FIG. 6 is a partially exploded view of the active identifier of FIG. 5.

### DETAILED DESCRIPTION OF PREFERRED EMBODIMENTS

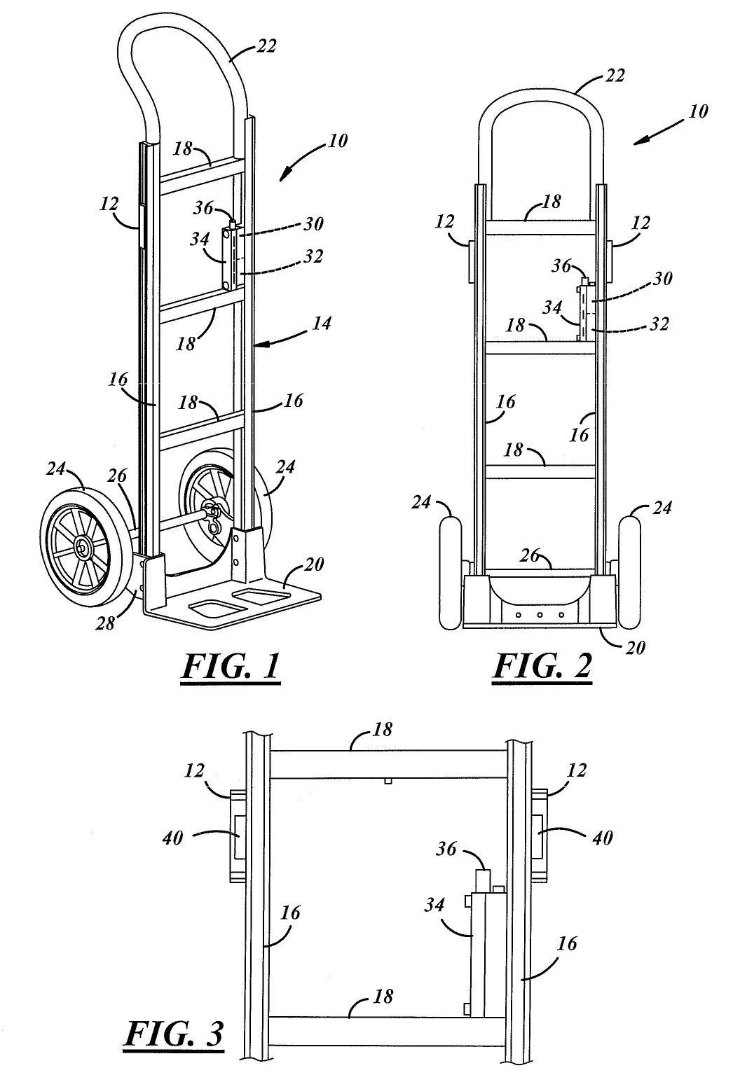

Referring in more detail to the drawings, FIGS. 1-4 illustrate one exemplary embodiment of a hand truck 10 with one or more identifiers 12 to provide a visual signal that facilitates determining the location and/or the position of the hand truck, or at least the identifier(s), to a viewer. The identifier(s) 12 may be “active” identifier(s) in the sense that they can be viewed without a separate source of light. That is, the active identifier(s) may provide their own light such that even in complete darkness (no ambient light), the identifier(s) can be viewed. While shown on a relatively simple hand truck the active identifier(s) can be used with different hand trucks or carts having more than two wheels, and can be used with manual or powered trucks or carts. As used throughout this document including the claims, “hand truck” includes a cart or other device.

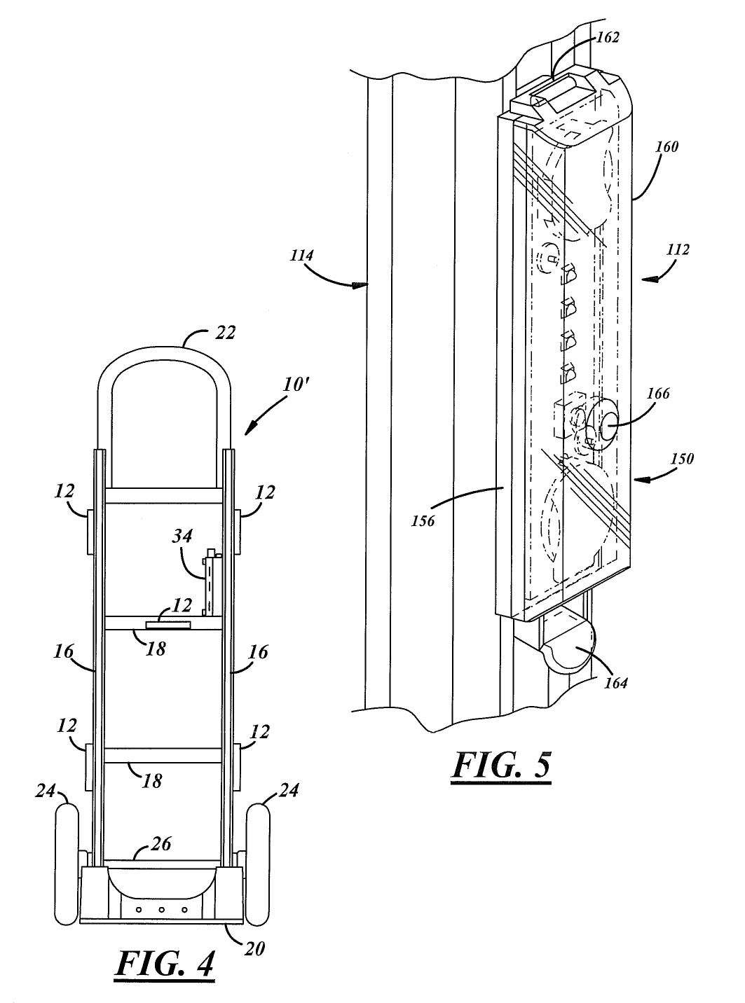

In the illustrated embodiment, the hand truck 10 may include: a frame 14 having one or more side rails 16 and one or more cross members 18 extending laterally between the side rail(s); a nose plate 20 extending laterally and forwardly of the side rail(s); a generally U-shaped handle 22 extending from the side rail(s) and canted rearwardly thereof for ease of handling by an operator of the hand truck; and a pair of wheels 24 disposed adjacent to the side rail(s) and carried by an axle 26 which itself may be carried on brackets 28 secured to the frame. In the illustrated embodiment, a pair of active identifiers 12 is carried by the frame 14, one on each of the side rails 16. As shown in an another embodiment of a hand truck 10′ of FIG. 4, any number of active identifier(s) 12 can be carried by the frame 14, on the side rail(s) 16, cross member(s) 18, handle 22, nose plate 20, brackets 28, the wheels 24, or any combination thereof, or elsewhere such as on a bracket or support extending from or carried by the frame or other component of the hand truck.

In the illustrated embodiment, a control 30 may be connected to and carried by the frame 14 or any other component of the hand truck 10 via a nut and bolt, adhesive, welding, or any other suitable way. The control 30 may include a power source 32 such as, by way of examples without limitation, a battery, one or more solar cells or devices, or a generator which may be driven by energy stored from rotation of the wheels 24. A single control and power source may be used for all active identifier(s) 12 on the hand truck 10. The control 30 may be communicated and electrically coupled to the active identifier(s) 12 by wires, or wirelessly through any suitable wireless protocol such as bluetooth. In a wireless setup, each active identifier 12 may need its own receiver for the wireless signal. The control 30 and any other related component may be carried in a common housing 34 or in one or more housings that may be adjacent one another or spaced apart, as desired. The housing 34 may be partially or fully contained in or defined by the frame 14 or a portion thereof. For example, the handle(s) 22, side rail(s) 16, and/or cross member(s) 18 may be tubular or open channel extrusions to which or in which the control 30 and power source 32 may be mounted.

The control 30 may also include one or more switches 36 disposed electrically between and electrically coupled to the power source 32 and the active identifier(s) 12 in order to control the application of electrical power to the active identifier(s). If desired, one switch 36 can be used to control application of power to all active identifiers 12. The switch 36 could be located at or on the control housing 34, or at any other convenient location on the hand truck 10. The switch 36 could be manually actuated, or the switch could be automatically actuated such as, for example, upon detection of an amount of ambient light below a threshold, upon rotation of the wheels 24 beyond a threshold, or a combination of both requiring low ambient light and sufficient wheel rotation. In this situation, the control 30 could also include an ambient light sensor and/or a wheel rotation sensor having an output used to control application of power to the active identifier(s) 12. As other examples for locations of the switch(es) 36, a switch could be mounted on the handle 22 in a location and arrangement where the switch would be actuated when an operator grabs the handle to move the hand truck 10. In this manner, the switch(es) 36 would be actuated and power supplied to the active identifier(s) 12 whenever the operators hand engages the handle 22 in the area of the switch(es). To avoid unnecessarily draining the power source, the control 30 may include a timer that switches off the power to the active identifier(s) 12 after a predetermined period of time.

The active identifier(s) 12 may include a light source 40 (FIG. 3) of any variety including one or more electrically driven light sources such as light bulbs, LEDs, OLEDs, or the like. As previously noted, the active identifier(s) 12 may be active in that no separate light source is needed to view them even in very low or no ambient light conditions. When power is not applied to or communicated with the active identifier(s) 12, they may have light reflective properties or materials to reflect light from another source and provide passive identification of the hand truck's location.

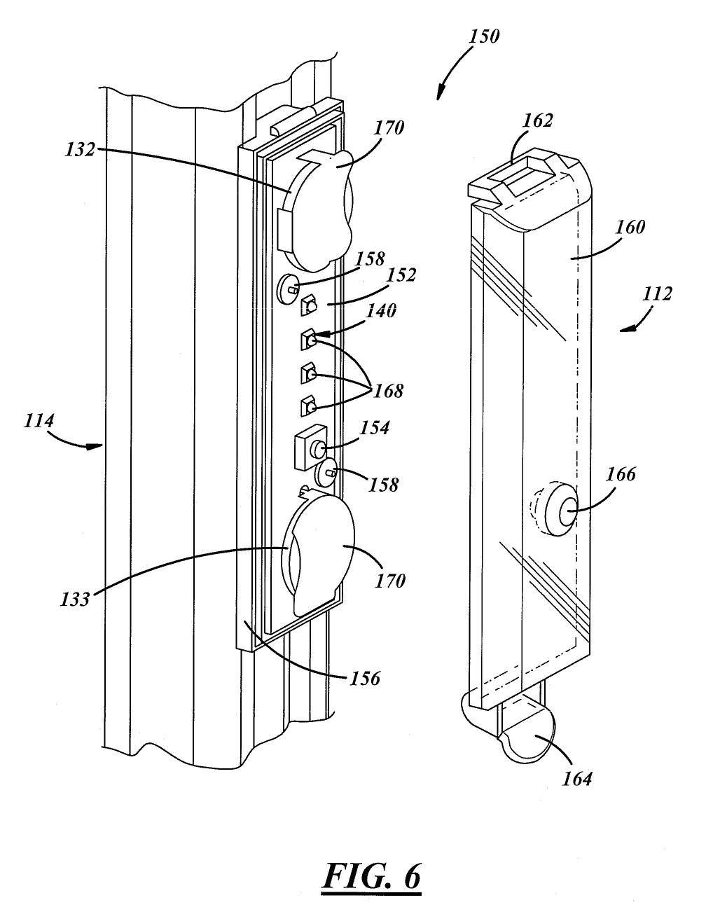

FIGS. 5 and 6 illustrate another exemplary embodiment of an active identifier 112 that may be used with the hand truck 10 of FIGS. 1-4. In this illustrated embodiment, the control 30 of FIGS. 1-4 may be integrally incorporated in the active identifier 112 to provide a single component, or the control may simply not be provided. The active identifier 112 may include a housing 150, a printed circuit board 152, a light source 140, one or more power source(s) 132, 133, and a switch 154.

The housing 150 may include a base 156 connected to a frame 114 via a screw 158, press-fitting, adhesion, welding, or any other suitable way. The base 156 may carry and support the circuit board 152. The housing 150 may also include a cover 160 removably connected to the base 156 via a first clip 162 and a second clip 164. The cover 160 may include a button 166 located over the switch 154 and manually pressible up and down by an operator to engage and thus actuate and deactuate the switch. In the illustrated embodiment, the cover 160 may be translucent so that the light source 140 can be viewed therethrough, but in another embodiment the cover may be translucent only at or near the light source, or may have a window. The circuit board 152 may support the light source 140, the power source(s) 132, 133, and the switch 154, and may electrically couple them via conductive pathways or traces. The light source 140 may include four light-emitting-diodes (LEDs) 168 arranged in a row on the circuit board 152; of course any other number of light sources and arrangements may be used. The power source(s) 132, 133 may include lithium batteries such as CR2032 type batteries that are held in place to the circuit board 152 via battery holders or straps 170. The switch 154 is manually actuated to activate and deactivate the light source 140 and turn the light source on and off.

Subject matter described for the embodiments of FIGS. 1-4 can be incorporated with the embodiment of FIGS. 5-6, and vice versa. For example, a plurality of active identifiers 112 can be located at different positions on the frame 14 and can be managed at a single location by the control 30.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A hand truck, comprising:
a frame;
at least one wheel connected to the frame to facilitate moving the hand truck from place-to-place;
at least one active identifier connected to the frame and including at least one light source that illuminates without ambient light; and
a control electrically coupled to the at least one active identifier and including a power source to provide power to the at least one active identifier.

2. The hand truck of claim 1 wherein the frame includes a pair of side rails and a plurality of cross members, and the at least one active identifier is a plurality of active identifiers connected to at least one of the side rails or the cross members.

3. The hand truck of claim 1 wherein the at least one light source is at least one light-emitting-diode (LED).

4. The hand truck of claim 1 wherein the at least one active identifier is a separate component from the control and is electrically coupled to the control via at least one wire, the control being connected to the frame at a different location than the at least one active identifier.

5. The hand truck of claim 1 wherein the at least one active identifier is a single active identifier incorporated with the control to provide a single component, the active identifier including a housing supporting the at least one light source and the power source, the housing including a base connected to the frame and including a cover removably connected to the base and enclosing the at least one light source.

6. The hand truck of claim 5 wherein the active identifier includes a switch electrically coupled to the at least one light source and electrically coupled to the power source to activate the at least one light source on and off.

7. The hand truck of claim 6 wherein the active identifier includes a printed circuit board electrically coupled to the at least one light source, the power source, and the switch.

8. The hand truck of claim 7 wherein the cover includes a button located over the switch and manually pressible to engage and actuate and deactuate the switch.

9. A hand truck, comprising:
a frame;
at least one wheel connected to the frame to move the hand truck place to place; and
at least one active identifier including a housing with a base connected to the frame and with a cover removably connected to the base, the at least one active identifier including at least one light source supported by the housing and enclosed by the cover, and including a power source supported by the housing to provide power to the at least one light source.

10. The hand truck of claim 9 wherein the frame includes a pair of side rails and a plurality of cross members, and the at least one active identifier is a plurality of active identifiers connected to at least one of the side rails or the cross members.

11. The hand truck of claim 9 wherein the at least one light source is at least one light-emitting-diode (LED).

12. The hand truck of claim 9 wherein the at least one active identifier includes a switch electrically coupled to the at least one light source and to the power source to activate the at least one light source on and off.

13. The hand truck of claim 12 wherein the at least one active identifier includes a printed circuit board electrically coupled to the at least one light source, the power source, and the switch.

14. The hand truck of claim 13 wherein the cover includes a button located over the switch and manually pressible to engage and actuate and deactuate the switch.
